(19) United States
(12) Patent Application Publication
(10) Pub. No.: US 2025/0140029 A1
(43) Pub. Date: May 1, 2025

(54) Power Line Communication (PLC) Self-Test for Tractor-Trailers

(71) Applicant: Bendix Commercial Vehicle Systems LLC, Avon, OH (US)

(72) Inventors: Shawn D. Lammers, Delta (CA); Michael D. Cremona, Lakewood, OH (US); Timothy J. Frashure, Columbia Station, OH (US)

(73) Assignee: Bendix Commercial Vehicle Systems LLC, Avon, OH (US)

(21) Appl. No.: 18/385,482

(22) Filed: Oct. 31, 2023

(51) Int. Cl. G07C 5/00

(52) U.S. Cl. CPC G07C 5/008

(57) ABSTRACT

A power line communication (PLC) self-test for tractor-trailers is provided. The self-test can be performed in a brake controller comprising a PLC transmitter configured to couple with a power line providing power from a tractor to at least one trailer coupled with the tractor. In the self-test, the brake controller causes the PLC transmitter to send a PLC test message on the power line and determines whether the brake controller received the PLC test message from a PLC receiver. If the brake controller did not receive the PLC test message from the PLC receiver, a fault message is generated. The PLC receiver can be in the brake controller or in a PLC receive electronic control unit (ECU), for example. Other embodiments are provided.

### BACKGROUND

Power line communication (PLC) is a communication method in which data is transmitted over wires that are also used to deliver electric power. The data is encoded within a signal that is transmitted over the wires in frequency ranges outside of those used to transmit electric power. PLC is advantageous relative to other communication methods because it enables communication using existing wiring. Tractor-trailers frequently employ PLC to exchange messages between members of the tractor-trailer including, for example, sensor readings from vehicle systems including anti-lock braking systems, collision avoidance systems, tire pressure monitoring systems, and other vehicle systems, as well as commands used to control anti-lock braking systems, lighting systems, and other vehicle systems.

### BRIEF DESCRIPTION OF THE DRAWINGS

FIG. 1 is a diagram of a vehicle of an embodiment including a plurality of electronic systems communicating along a power line in the vehicle.

FIG. 2 is a block diagram of a tractor-trailer of an embodiment, where the tractor comprises a PLC receive electronic control unit (ECU).

FIG. 3 is a block diagram of a tractor-trailer of an embodiment, where the tractor comprises a brake controller with a PLC receiver.

FIG. 4 is a flow chart of a PLC self-test method of an embodiment.

FIG. 5 is a flow chart of a PLC self-test method of an embodiment.

### SUMMARY

The following embodiments generally relate to a power line communication (PLC) self-test for tractor-trailers. In one embodiment, a brake system in a tractor is provided comprising a brake controller and a PLC receive electronic control unit (ECU). The brake controller comprises a power line communication (PLC) transmitter configured to couple with a power line providing power from the tractor to at least one trailer coupled with the tractor, wherein the PLC transmitter is further configured to send a PLC test message on the power line; and a data network receiver. The PLC receive ECU comprises: a PLC receiver configured to couple with the power line; and a data network transmitter configured to couple with the data network receiver of the brake controller via a data network. When the PLC receiver is operational, the PLC receive ECU is configured to receive the PLC test message from the power line and send the PLC test message to the brake controller via the data network transmitter.

In another embodiment, a brake controller is provided comprising: a power line communication (PLC) transmitter configured to couple with a power line providing power from a tractor to at least one trailer coupled with the tractor; a PLC receiver configured to couple with the power line; and one or more processors. The one or more processors, individually or in combination, are configured to: cause the PLC transmitter to send a PLC test message on the power line; determine whether the PLC receiver received the PLC test message from the power line; and in response to determining that the PLC receiver did not receive the PLC test message, cause a fault message to be generated.

In yet another embodiment, a method is provided that is performed in a brake controller comprising a power line communication (PLC) transmitter configured to couple with a power line providing power from a tractor to at least one trailer coupled with the tractor. The method comprises: causing the PLC transmitter to send a PLC test message on the power line; determining whether the brake controller received the PLC test message from a PLC receiver; and in response to determining that the brake controller did not receive the PLC test message from the PLC receiver, causing a fault message to be generated.

Other embodiments are possible, and each of the embodiments can be used alone or together in combination.

### DETAILED DESCRIPTION

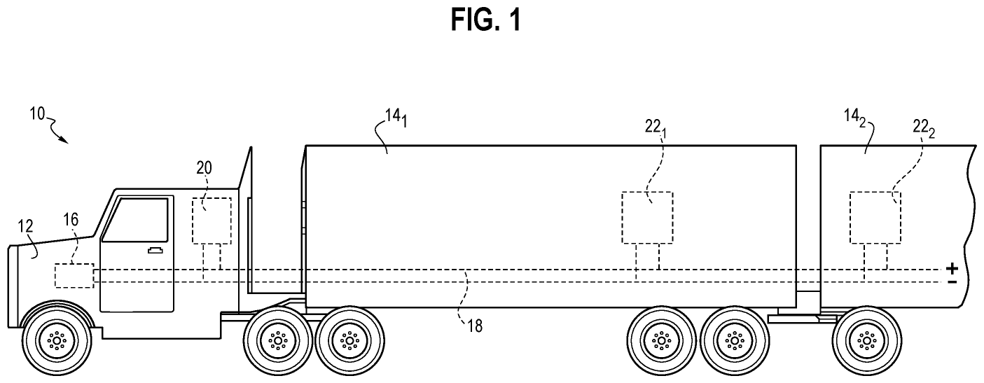

Turning now to the drawings, FIG. 1 illustrates a vehicle of an embodiment; in particular, a tractor-trailer 10. The tractor-trailer 10 contains a truck or tractor 12 and one or more trailers 14₁ . . . 14_{N}. In this embodiment, the tractor 12 contains a power unit, such as an internal combustion engine, and steering and drive axles. The tractor 12 also contains a battery 16 for use in starting the power unit and in providing power to various accessory systems. Trailers 14₁ . . . 14_{N} are provided to store freight and are detachably coupled to the tractor 12. Although a pair of trailers 14 is shown in the illustrated embodiment, it should be understood that fewer or more trailers can be used. In one example, up to five total trailers can be used. In other examples, a different number of trailers can be used.

The tractor 12 and the trailers 14 may include various fluid (e.g., air) and power lines that extend between the tractor 12 and the trailers 14, including power line 18. The fluid and power lines allow delivery of fluids and electrical power from the tractor 12 to the trailers 14 for use in, for example, tire pressure management, braking, and activation of tail lights on the trailer 14. The power line 18 is also used for power line communication (PLC) to transmit data over wires that are also used to deliver electric power. The data is encoded within a signal that is transmitted over the wires in frequency ranges outside of those used to transmit electric power.

In this example, the power line 18 forms part of a network used to transmit communications between various brake controllers 20, 22₁ . . . 22_{N} on the tractor 12 and the trailers 14, respectively. As used herein, a brake controller (sometimes referred to herein as an electronic control unit (ECU)) can comprise one or more processors that can execute computer-readable program code having instructions (e.g., modules, routines, sub-routine, programs, applications, etc.) that, when executed by the one or more processors, individually or in combination, cause the one or more processors to perform certain functions, such as some or all of those discussed herein. The computer-readable program code can be stored in a non-transitory computer-readable storage medium, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. The one or more processors can also take the form of a purely-hardware implementation (e.g., an application-specific integrated circuit (ASIC)). In one embodiment, one or more of the brake controllers provide antilock braking system (ABS) and/or electronic braking system (EBS) functionality.

Although not shown in FIG. 1 to simplify the drawings, other systems can also be connected to the power line 18. Such systems include, but are not limited to, collision avoidance systems, tire pressure monitoring and control systems, trailer load monitoring systems, and lighting systems.

The power line 18 may enable transmission of data from one or more brake controllers 22 on the trailers 14 to the brake controller 20 on the tractor 12 including, for example, sensor readings indicative of the operation of an anti-lock braking system. The power line 18 may also enable transmission of commands and data from the tractor 12 to the trailers 14 for use in controlling elements of the anti-lock braking system, for example,

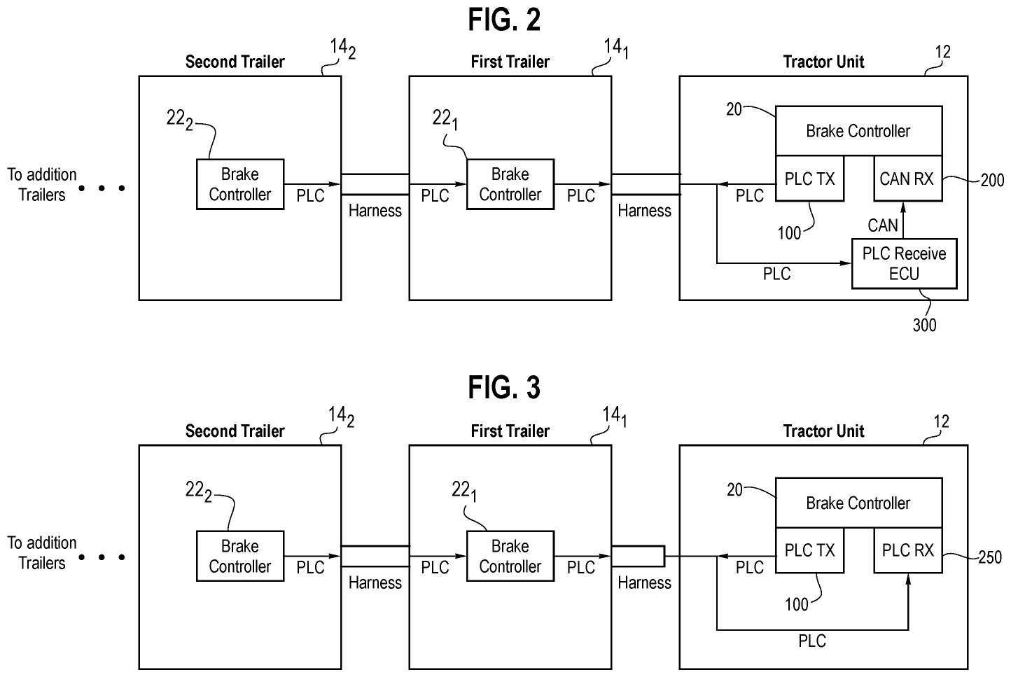

In one embodiment (see FIG. 2), the brake controller 20 in the tractor 12 has a PLC transmitter 100 but does not have a PLC receiver. This means that the brake controller 20 in the tractor 12 can transmit messages to the brake controllers 22 in the trailers 14 but cannot directly receive messages transmitted from the trailers 14. However, the brake controller 20 in the tractor 12 has a receiver 200 that can receive messages over a data communications network, such as a controller area network (CAN). So, in this embodiment, a separate PLC receive ECU 300 (which can comprise one or processors and be an ECU) is used to receive messages sent on the power line, convert the message to another format, and relay those messages to the brake controller 210 over the data communications network. In another embodiment (see FIG. 3), the brake controller 20 in the tractor 12 has a PLC receiver 250, so a separate PLC receive ECU is not needed.

In either embodiment, it is possible for a problem to occur in the PLC receiver (e.g., in the PLC receive ECU 300 or the PLC receiver 250 in the brake controller 20) that prevents the PLC receiver from receiving messages on the power line. (Alternatively or additionally in either embodiment, there can be a problem with the PLC transmitter 100 in transmitting a PLC message.) For example, high temperatures encountered in a vehicle can cause a fault in the PLC receiver (again, either in the PLC receive ECU 300 or the PLC receiver 250 in the brake controller 20). The PLC communication system is an open-loop system, so there is no way to determine if there is a failure in the system that would prevent receptions of a PLC signal. So, a lack of a PLC signal can indicate that the brake controllers in the trailers are not transmitting a PLC signal (or that trailers are not connected to the tractor 12) or can indicate that there is fault in PLC receiver preventing it from receiving PLC signals that are being sent.

To address this problem, the brake controller 20 in the tractor 20 can send a test message (e.g., periodically) on the PLC line. If the PLC receiver is working properly, it should pick up this test message and send it back to the brake controller 20. This provides a closed-loop self-test. That is, if the brake controller 20 does not receive, from the PLC receiver, the test message that it is transmitted, the brake controller 20 can know there is a fault with the PLC receiver. (There can also or instead by a fault with the PLC transmitter.) The brake controller 20 can then send a fault message (e.g., via CAN) to another component in the vehicle (e.g., to display a fault warning on the dash).

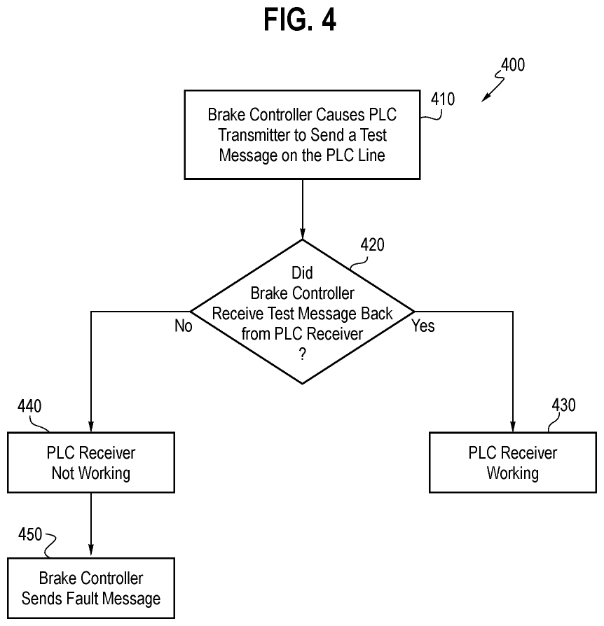

FIG. 4 is a flow chart 400 that illustrates this method. As shown in FIG. 4, the brake controller 20 causes the PLC transmitter 100 to send a test message on the PLC line (act 410). The brake controller 20 then determines if it received the test message back from the PLC receiver (either in the brake controller 20 or in the PLC receive ECU 300, depending on the implementation) (act 420). If the brake controller 20 determines that it received the test message back from the PLC receiver, the brake controller 20 concludes that the PLC receiver is working properly (act 430). However, if the brake controller 20 determines that it did not receive the test message back from the PLC receiver, the brake controller 20 concludes that the PLC receiver is not working properly (act 440) and sends a fault message (e.g., via CAN to another vehicle ECU that provides an alert on the dash) (act 450).

In summary, this embodiment provides an embedded self-test method for PLC reception in the tractor system. This can be accomplished by using an additional transmitting ECU on the tractor that can create a test PLC message that can be received by the main PLC receive ECU (e.g., the PLC receive ECU) with a feedback of the status using the serial communication link between the ECUs. This can detect if the main PLC receiving ECU is not capable of performing the PLC function, which can be a regulatory issue. In one example implementation, the transmit ECU can transmit a special heart-beat PLC message on a regular basis. The PLC receiver ECU (e.g., the PLC receive ECU) can receive this heart-beat message and send confirmation back to the transmit ECU. This message can be simple or complex to verify other criteria (e.g., longer messages, etc.). The transmit message can be further defined to be a minimal voltage or other condition to verify correct compliance. The transmit ECU can then create a specific ECU fault for the loss of PLC. This can be made very robust and only fault when absolutely necessary, and this can be allowed to self-heal. Further, as mentioned above, in another embodiment, a single ECU can use redundant circuits or software. This can be accomplished with a number of ECUs on the tractor that have the ability to transmit PLC or create a test message.

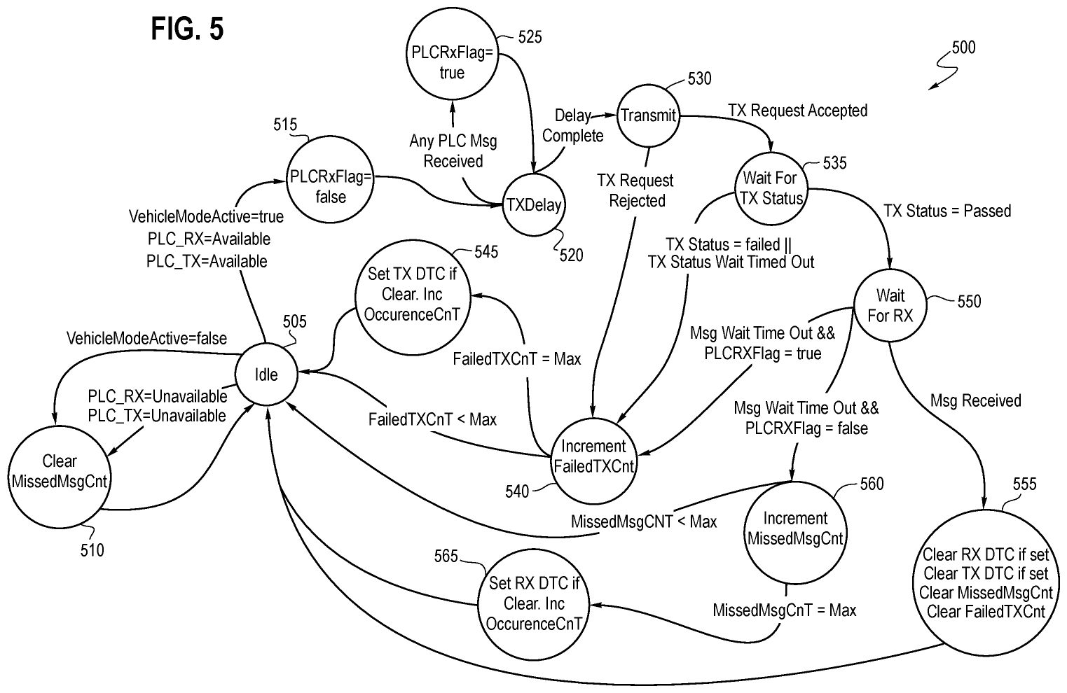

Turning again to the drawings, FIG. 5 is a flow chart 500 of a PLC self-test method of an embodiment. This method can be used with implementations where the PLC receiver is in the brake controller 20 or with implementations wherein the PLC receiver is in a PLC receive ECU. Further, this method can be implemented by one or more processors in the brake controller 20 executing software, for example. It should be understood that this is merely an example and that other methods can be used. Accordingly, the details presented herein should not be read into the claims unless expressly recited therein.

As shown in FIGS. 1 and 5, the brake controller 20 starts in an idle state (act 505). The brake controller 20 monitors whether the vehicle is in an active mode (e.g., providing power to the trailer(s), not parked, etc.), whether the PLC receiver is available, and whether the PLC transmitter 100 is available. If all three conditions are true, the brake controller 20 sets a PLC receiver flag to false (act 515). Otherwise, the brake controller 20 clears a missed message count (act 510). After the brake controller 20 sets the PLC receiver flag to false, a delay is presented (act 520), and, after the delay is completed, the PLC test message is transmitted (act 530). However, if, during the delay, an PLC message is received, the PLC receive flag is set as true (act 525). Also, if the transmit request is rejected, the brake controller 20 increments the failed transmit count (act 540), and then a transmit diagnostic trouble code (DTC) is set, if clear (act 545).

After the PLC message is sent, the brake controller 20 waits for a transmit status (act 535). If the transmit status indicates passed, the brake controller 20 waits for the receiver (act 550). However, if the transmit status indicates a failure, the brake controller 20 increments the failed transmit count (act 540). If a message is received, various indicators are cleared (act 555), and the brake controller 20 returns to idle mode (act 505). However, if the message was not received, the missed message count is incremented (act 560), and the receive DTC is cleared (act 565).

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A brake system in a tractor, the brake system comprising:
a brake controller comprising:
a power line communication (PLC) transmitter configured to couple with a power line providing power from the tractor to at least one trailer coupled with the tractor, wherein the PLC transmitter is further configured to send a PLC test message on the power line; and
a data network receiver; and
a PLC receive electronic control unit (ECU) comprising:
a PLC receiver configured to couple with the power line; and
a data network transmitter configured to couple with the data network receiver of the brake controller via a data network;
wherein, when the PLC receiver is operational, the PLC receive ECU is configured to receive the PLC test message from the power line and send the PLC test message to the brake controller via the data network transmitter.

2. The brake system of claim 1, wherein the brake controller comprises one or more processors that are configured, individually or in combination, to cause a fault message to be sent in response to not receiving the PLC test message from the PLC receive ECU.

3. The brake system of claim 2, wherein the fault message is sent on the data network.

4. The brake system of claim 1, wherein the data network comprises a controller area network (CAN).

5. The brake system of claim 1, wherein the PLC transmitter is further configured to send a PLC message on the power line to at least one brake controller in the at least one trailer.

6. The brake system of claim 1, wherein the PLC receive ECU is further configured to receive a PLC message on the power line from at least one brake controller in the at least one trailer.

7. The brake system of claim 6, wherein the PLC message relates to an anti-lock brake function of the at least one trailer.

8. A brake controller comprising:
a power line communication (PLC) transmitter configured to couple with a power line providing power from a tractor to at least one trailer coupled with the tractor;
a PLC receiver configured to couple with the power line; and
one or more processors, individually or in combination, configured to:
cause the PLC transmitter to send a PLC test message on the power line;
determine whether the PLC receiver received the PLC test message from the power line; and
in response to determining that the PLC receiver did not receive the PLC test message, cause a fault message to be generated.

9. The brake controller of claim 8, wherein the fault message is sent on a data network.

10. The brake controller of claim 9, wherein the data network comprises a controller area network (CAN).

11. The brake controller of claim 8, wherein the PLC transmitter is further configured to send a PLC message on the power line to at least one brake controller in the at least one trailer.

12. The brake controller of claim 8, wherein the PLC receiver is further configured to receive a PLC message on the power line from at least one brake controller in the at least one trailer.

13. The brake controller of claim 12, wherein the PLC message relates to an anti-lock brake function of the at least one trailer.

14. A method comprising:
performing in a brake controller comprising a power line communication (PLC) transmitter configured to couple with a power line providing power from a tractor to at least one trailer coupled with the tractor:
causing the PLC transmitter to send a PLC test message on the power line;
determining whether the brake controller received the PLC test message from a PLC receiver; and
in response to determining that the brake controller did not receive the PLC test message from the PLC receiver, causing a fault message to be generated.

15. The method of claim 14, wherein the PLC receiver is part of the brake controller.

16. The method of claim 14, wherein the PLC receiver is part of a PLC receive ECU in communication with the brake controller over a data network.

17. The method of claim 16, wherein the data network comprises a controller area network (CAN).

18. The method of claim 14, wherein the brake controller causes the PLC transmitter to send the PLC test message in response to determining that the PLC transmitter and the PLC receiver are available and that the tractor is in an active mode.

19. The method of claim 14, further comprising periodically causing the PLC transmitter to send the PLC test message on the power line.

20. The method of claim 14, further comprising concluding that the PLC receiver is functional in response to receiving a PLC message from a brake controller in the at least one trailer before the PLC receiver receives the PLC test message.
